(19) United States
(12) Patent Application Publication
(10) Pub. No.: US 2013/0187764 A1
(43) Pub. Date: Jul. 25, 2013

(54) DYNAMIC ANALOG AUTHENTICATION

(71) Applicant: John Stephen Smith, San Jose, CA (US)

(72) Inventor: John Stephen Smith, San Jose, CA (US)

(73) Assignee: ALIEN TECHNOLOGY CORPORATION, Morgan Hill, CA (US)

(21) Appl. No.: 13/355,454

(22) Filed: Jan. 20, 2012

(51) Int. Cl. G06K 7/01

(52) U.S. Cl. 340/10.42

(57) ABSTRACT

Methods and apparatuses that receive an analog signal to provide a challenge to a device are described. The challenge may include a digital selection and an analog attribute of the analog signal. The analog attribute may be associated with an attribute value in an analog domain. Physical characteristics of the device may be evaluated according the analog challenge. A digital response may be generated as a result of the evaluation responding to the analog challenge. The combination of the digital challenge, the analog challenge, and the digital response may authenticate the device.

### FIELD OF INVENTION

The present invention relates generally to device authentication. More particularly, this invention relates to dynamic device authentication based on analog signals.

### BACKGROUND

Chip devices may be cloned by black market chip manufactures in many different ways. For example, emulators may be built from components and FPGA (field programmable gate array) to mimic hardware and/or software aspects of an authentic device. Programmable chips programmed with proprietary algorithms may be cloned if raw chips (e.g. not yet programmed) and the algorithms are stolen.

One approach to protect a device against cloning is based on an array of symmetric bi-stable inverter buffers. The outputs of each buffer may be either 1 or 0 depending on random fluctuations as fingerprints of the device. However, a large number of buffers may be needed to make such fingerprints effective. As a result, these buffers tend to add significant burdens to manufacturing cost, such as silicon area of the device.

Alternatively, standard private/public key cryptography mechanisms may be employed to safeguard a device. Typically, such mechanisms require complicated cryptographic operations for encryption, decryption, and/or key generation. Thus, in addition to allocating hardware resources in the device for implementing the cryptographic operations, substantial power may be consumed to perform these cryptographic computations.

Therefore, existing device authenticating mechanisms do not provide robust and cost effective solutions for device manufacturers to protect valid devices from being cloned.

### SUMMARY OF THE DESCRIPTION

In one embodiment, a dynamic authentication mechanism based on analog challenges is provided to validate whether a device (e.g. an RFID tag, a smart card, a chip, or other applicable hardware components) is authentic from a known source (or vendor). Commands with analog variations (or fluctuations, changes) in a waveform may be issued as a signal carrying an analog challenge to a target device. Analog circuitry on the target device may be stimulated by the incoming waveform of the commands to generate a digital signature as the analog challenge interacts with the analog circuitry intrinsically specific or unique with the target device. The analog features of the analog challenge can be varied over a large (or substantially unlimited) range to increase the scope of applicable challenge/response tests to develop a robust “signature” of the target device against cloned devices.

In another embodiment, an oscillator may be provided in a chip as an analog circuitry to respond to analog challenges to uniquely characterize the chip in an analog domain. The oscillator may be associated with multiple current sources. Each current may be derived from transistor circuits and/or resistive components whose parameters vary with normal manufacturing process variations. Different combinations of varying currents may be configured for the oscillator circuit to cause variations of the oscillation frequency of the oscillator circuit. In one embodiment, a number of cycles determined by timing intervals provided, for example, from a reader device, may be captured to measure the oscillation frequency. The reader device may command the chip to user different current sources and provide different timing intervals to compare resulting oscillation counts with previously measured counts to determine whether the chip is authentic.

An embodiment of the present invention includes a method and apparatus that receive an analog signal to provide a challenge to a device. The challenge may include a digital selection and an analog attribute of the analog signal. The analog attribute may be associated with an attribute value in an analog domain. Physical characteristics of the device may be evaluated according the analog challenge. A digital response may be generated as a result of the evaluation responding to the analog challenge. The combination of the digital response and the analog challenge may authenticate the device or contribute to authenticating the device (e.g. a specific instance of an RFID tag).

In an alternative embodiment, a challenge including a digital portion and an analog portion may be sent to a device to validate authenticity or identity of the device. The analog portion of the challenge may include an analog value represented by a continuous time varying feature in an analog signal. The continuous time varying feature can allow substantially unlimited number of possible selections of the analog value for the challenge. The challenge may be associated with a response to authenticate an authentic device or a type of authentic devices. A digital response (e.g. digital data) may be received from the device responding to the challenge. The device may be validated according to the digital response and the challenge. In certain embodiments, the device may not be validated as the authentic device or the type of authentic devices if the digital response fails to match the response associated with the challenge.

In yet another alternative embodiment, a challenge may be provided to specify an analog challenge as a random one of unlimited number of possible analog values within a known analog range. A signal representing the challenge may be sent to the device. The analog challenge may correspond to an analog attribute of the signal. Digital data may be received from the device responding to the analog challenge. The digital data may be paired with the analog challenge to establish fingerprints of the device.

Other features of the present invention will be apparent from the accompanying drawings and from the detailed description that follows.

### BRIEF DESCRIPTION OF THE DRAWINGS

The present invention is illustrated by way of examples and not limitation in the figures of the accompanying drawings, in which like references indicate similar elements and in which:

FIG. 1 is a system diagram illustrating one embodiment of dynamic analog authentication described herein;

FIG. 2 is a block diagram illustrating one embodiment of system components for analog authentication;

FIG. 3 is a block diagram illustrating one embodiment of circuits including an oscillator to perform analog authentication for a device;

FIG. 4 is a waveform diagram illustrating an exemplary analog signal for dynamic authentication described herein;

FIG. 5 is a flow diagram illustrating one embodiment of a process to generate a digital response for an analog challenge;

FIG. 6 is a flow diagram illustrating one embodiment of a process to send an analog challenge to receive a digital response;

FIG. 7 is a flow diagram illustrating one embodiment of a process to provide challenges with analog values to uniquely characterize a device;

FIG. 8 illustrates one example of a typical clone protected system which may be used in conjunction with an embodiment described herein;

FIG. 9 illustrates an example of a data processing system that may be used with one embodiment of a clone protected device of the present invention.

### DETAILED DESCRIPTION

Methods and apparatuses for device authentication operations are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “host”, “device”, “interrogator” and “tag” are intended to refer generally to data processing systems rather than specifically to particular form factors.

In one embodiment, physical properties of a device (e.g. an RFID tag, a smart card, a chip etc.) may be functions of how the device was made (or manufactured), such as specific environments, machinery states, specific foundry, wafer materials or other factors which are uniquely built into each individual device and not possible to reproduce to a different device. For example, resistance level of a common resistor component (or other measurable levels of physical properties) in different devices made by a common manufacturing process may vary randomly by certain percentage points which may not be externally controllable. Such properties may provide unique and specific fingerprints which are inherently analog in nature to validate the device using an analog domain or dimension.

In some embodiments, different types of devices or chips may be profiled or characterized due to variations of manufacturing processes, equipments, environmental settings or factors (e.g. uncontrollable). These types may be identified from these devices based on selection of analog challenges to these devices. Different profiles may be established among a collection of devices by using different analog challenges. Typically, the number of profiles or types for the collection of devices may increase with amount of variations among analog challenges adopted. Analog variations in analog challenges may allow significant variations in device profiles to strengthen protection against device cloning attempts.

For example, a device may include an oscillator circuit oscillating at a frequency unique to the device. The frequency may correspond to an analog value which can be one of an infinite number of possible values even within a known range with fixed upper and lower bounds. The oscillator circuit may compose passive components to generate repetitive electronic signals. A passive component, such as resistor, transistor, capacitor, etc, may consume (but does not produce) energy, or may be incapable of power gain. The repetitive signal may be provided by a comparison against a threshold level (e.g. current or voltage level) or a mismatch between threshold levels, which may depend on intrinsic physical properties of the device to provide the unique frequency.

In one embodiment, an oscillator circuit or other applicable circuit in a device may include configurable components to provide additional variations for analog fingerprints to strengthen validation capability (e.g. making it harder to duplicate or mimic the fingerprints). A configurable component may be, for example, a resistor with varied resistance, switches changing resistor networks, bias voltages on transistors, or other applicable components with variable levels of physical characteristics, which may be externally controllable. As components are configured with different settings, the oscillator circuit may oscillate in different frequencies (in analog domain).

According to one embodiment, an oscillation frequency may be measured in an analog manner by counting how many times oscillation occurs during an analog time interval. A range of potential oscillation frequencies may be recorded as reproducible range of numbers by repeating the counting multiple times. In one embodiment, existing circuitry of a device, such as an RFID tag, may be available for counting oscillation frequencies without requiring additional circuitry or resources (e.g. silicon areas) to establish analog fingerprints for the device.

Analog fingerprints of a device may be established in an analog manner without digital constraints in representing certain analog values because of precision limitations (e.g. caused by finite number of bits). Analog values may include frequency, temperatures, power level, light level, and/or other applicable measurable physical properties which are analog in nature, etc. A device may be capable of providing analog links (e.g. based on RF wireless connections, or other applicable wired or wireless connections) for setting up communication channels with other devices. In some embodiments, the analog links may be leveraged to carry analog challenges to authenticate the device using analog fingerprints.

For example, a profile of an RFID tag device may be established to include multiple analog challenges with expected responses previously recorded. Each challenge may include an analog value, such as a time interval, randomly selected from an analog domain (e.g. time domain). An RFID reader may send a challenge to the RFID tag device and retrieve an answer of the challenge back from the RFID tag to compare with the corresponding expected response of the challenge to determine whether the answer is correct or not (e.g. whether the answer is substantially the same as the expected corresponding response). The infinite variations of potential analog values selectable for the challenges can make the profile extremely difficult to duplicate or clone.

In one embodiment, an analog challenge may include configuration parameters, such as a digital value, which could provide one of several possible settings of physical characteristics in a target device to generate expected responses. Each setting may alter actual analog behavior or function of a circuitry in the target device, which is effectively hard or practically impossible to clone. The configuration parameters may add another layer of variations (e.g. 16 variations using 4 bits of configuration parameters) to strengthen a profile using the analog challenge.

According to one embodiment, a clone protected RFID tag device may include a ring oscillator circuitry to allow change of circuit components on the fly, for example, to vary physical properties of the circuitry. The ring oscillator may, for example, include multiple (e.g. odd numbered) current starved devices. Oscillation frequency of the ring oscillator may depended on defined currents instead of defined voltages (e.g. to minimize required silicon area in the tag). The currents may be determined by a reference voltage and chains of resistors or variable resistors. Configuration parameters sent to the tag may include, for example, instructions to short one or more of the resistors to change the currents.

An oscillator circuit may comprise current starved inverters and resistors to generate an oscillation frequency as a function of exact resistance of each resistor. Thus, the oscillation circuit may convert physical parameters to an analog frequency number. Accurate measurement of the frequency number may be based on simple counting of a number of oscillations over a period of time. Typically, the longer the period of counting, the more precise the measurement is. Further, different oscillation frequencies may result from turning on/off segments of the resistors.

In one embodiment, an RFID reader may provide an analog challenge including a digital number and an analog number to authenticate a target RFID tag device. The digital number may specify which circuit components to activate or use in the tag device and the analog number may supply a time interval to start and stop counting a number of oscillations generated from an oscillation circuit. The tag may return the number of times the oscillation circuit oscillates back to the reader as a response to establish a profile for the tag based on the analog challenge paired with the response.

In other embodiments, responses to analog challenges from a device may vary depending on working environments, such as temperatures, pressures or other applicable measurable externally measurable factors. A profile of the device may include specific environmental settings (or range of settings) associated with a response for a particular analog challenge. For example, an oscillator circuit may oscillate in different frequencies when similarly challenged (e.g. in an analog manner) under different temperatures, even with common configuration settings (or parameters). Thus, proper environmental controls (e.g. cooling down or heating up to a preset range of analog temperature values as profiled) on the device may be required for device authentication as additional analog variations to profile the device. Additionally or alternatively, the temperature, light level, or the like may be recorded as an additional contribution to the analog challenge. Each analog attribute or value for challenging the device may provide one separate dimension of uncertainty to reduce the possibility of counterfeiting the device.

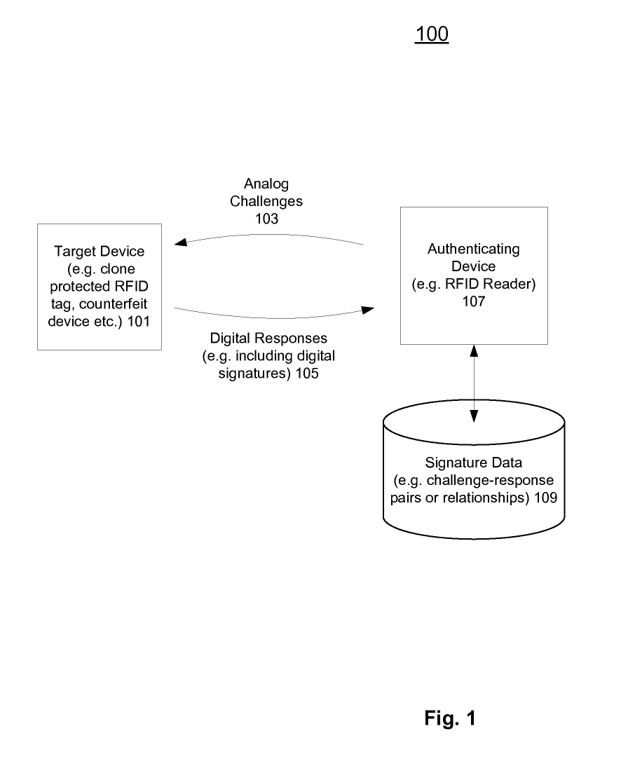

FIG. 1 is a system diagram illustrating one embodiment of dynamic analog authentication described herein. In one embodiment, system 100 may include authenticating device 107 dynamically validating target device 101 via analog challenges 103 and digital responses 105. For example, authenticating device 107 may be an RFID reader (or writer) device coupled with signature database 109 (or applicable storage mechanisms) storing profiles of genuine devices from a vendor. Each profile may include multiple challenge response pairs or combinations in analog domains.

Target device 101 may be an RFID tag which may be a clone protected genuine device or a counterfeit device. Device 107 may send analog challenges 103, for example, via RF wireless connections or other network connections, to target device 101 according signature data 109. In one embodiment, authenticating device 107 may select pairs of challenges/responses from profiles stored in signature data 109 to challenge target device 101 in an analog manner. The selection may be based on certain properties of the device, such as model number, types, serial number etc. The challenges may include analog values carried by analog attributes of a signal encoding digital data from authenticating device 107 to target device 101. The analog values may range beyond representation precisions of digital data allowed in the signal.

Target device 101 may generate digital responses 105 according to received analog challenges 103. In one embodiment, target device 101 may store generated digital responses 105 for later retrieval by authenticating device 107. For example, authentication device 107 may send a special RFID read command to retrieve latest digital responses from a certain RFID memory address (e.g. predetermined or known) of target device 101. Authenticating device may collect digital responses 105 from device 101 to compare with corresponding profile stored in signature data 109 to determine whether a match could be identified (e.g. based on allowable measures of maximum errors (or other applicable statistical comparisons) in matching two sets of numbers representing digital responses and expected responses in the profile) to validate target device 101.

In one embodiment, signals between authenticating device 107 and target device 101 may include custom RFID commands (e.g. digital data carried in the signals) to configure, set up or tune target device 101 before generating digital responses 105. For example, target device 101 may include an oscillator circuit oscillating at certain intrinsic frequencies unique to the target device 101. The custom commands may instruct target device 101 to select one of a variety (e.g. based on four bits for sixteen possible variations) of intrinsic frequencies on the fly to generate the digital responses 105.

In one embodiment, analog challenges 103 may include time intervals (or tick counts) indicated in signal waveforms carrying custom commands from authenticating device 107. Target device 101 may count the number of oscillations of an oscillator circuit during the time intervals and store the counted number in a memory already allocated and available. Subsequently, authenticating device 107 may send a query command to target device 101 to retrieve the counted number for validation. In some embodiment, authenticating protocols between target device 101 and authenticating device 107 may be bootstrapped from existing RFID tag reader protocols to minimize implementation cost for tag authentication.

In one embodiment, a sequence of pulses used to determine a time interval for communication in a protocol may also be used to generate an analog time interval challenge, using the same oscillator and counter for both purposes. In one embodiment, a custom command may be used to set the digital portion of a challenge, including resistor values to establish an oscillator frequency for the master oscillator of the chip, and the preamble of a query command in the ISO (International Organization for Standardization)-18000-6c protocol to establish the TRCal interval is used to register a variable length interval (the analog challenge) into the register normally used to hold a TRCal count, and the value of that count is presented as a field of the Tag ID of that protocol.

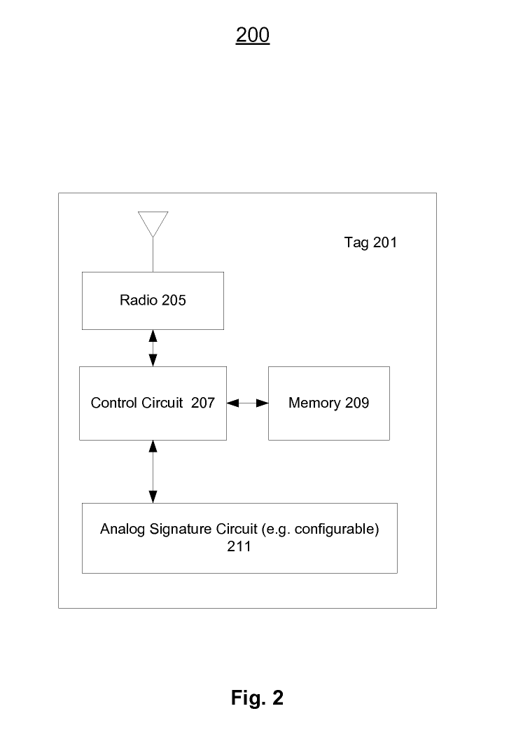

FIG. 2 is a block diagram illustrating one embodiment of system components for analog authentication. System 200 may include clone protected tag 201 capable of dynamically responding to analog challenges for authentication, such as in device 101 of FIG. 1. For example, tag 201 may include common RFID components, including radio 205 with antennae or other circuitry for receiving RF energy and reflecting or transmitting wirelessly information stored in memory 209.

In one embodiment, tag 201 may include control circuit 207 to identify a challenge from signals received via radio 205, for example, through a dipole antenna. The challenge may include analog parameters directly measurable from waveforms of the signals and, additionally or optionally, digital data embedded in the signals. For example, control circuit 207 can recognize whether signals received via radio 205 represent common RFID commands or analog challenges for device authentication.

A challenge carried via received signals may include analog portions and digital portions. Analog attributes, such as time intervals, may be detected or measured directly from received signals as the analog portions of the challenge. In one embodiment, configuration parameters may be extracted from the digital portions (or digital data) of the challenge. If a challenge is received with configuration parameters, control circuit 207 may configure analog signature circuit 211 to add an additional dimension of variance in generating an analog signature for authentication purposes.

In one embodiment, analog signature circuit 211 may provide a signature uniquely characterizing secret hardware or software properties of tag 201, which are not known outside of tag 201. For example, analog signature circuit 211 may oscillate with a unique frequency specific to tag 201 which is intrinsic based on physical properties of tag 201 and cannot be cloned even using the same manufacturing equipment and process to produce tag 201. The signature may be analog in nature based on a combination of an output from analog signature circuit 211 and the corresponding analog challenge.

In some embodiments, analog signature circuit 211 may be configurable according to configuration parameters of a received challenge via control circuit 207. For example, different sets of configuration parameters may configure or cause an oscillator circuitry in analog signature circuit 211 to oscillate at different frequencies as varied signatures for tag 201. Each of the varied (or configured) signatures may still be unique and specific to tag 201.

In one embodiment, control circuit 207 may obtain a measure of an output from signature circuit 211, such as number of oscillations, based on analog challenges received. For example, the analog challenges may indicate when to start and stop counting oscillations of analog signature circuit 211. Alternatively, the analog challenges may specify an analog value as a time interval to count the number of oscillations. Control circuit 207 may store the output measured, such as the counted number of oscillations, in a specific (e.g. pre-specified) address in memory 209, which may be non-volatile and accessible via an access command. The measured output may be combined with the analog challenge to form an analog signature for tag 201.

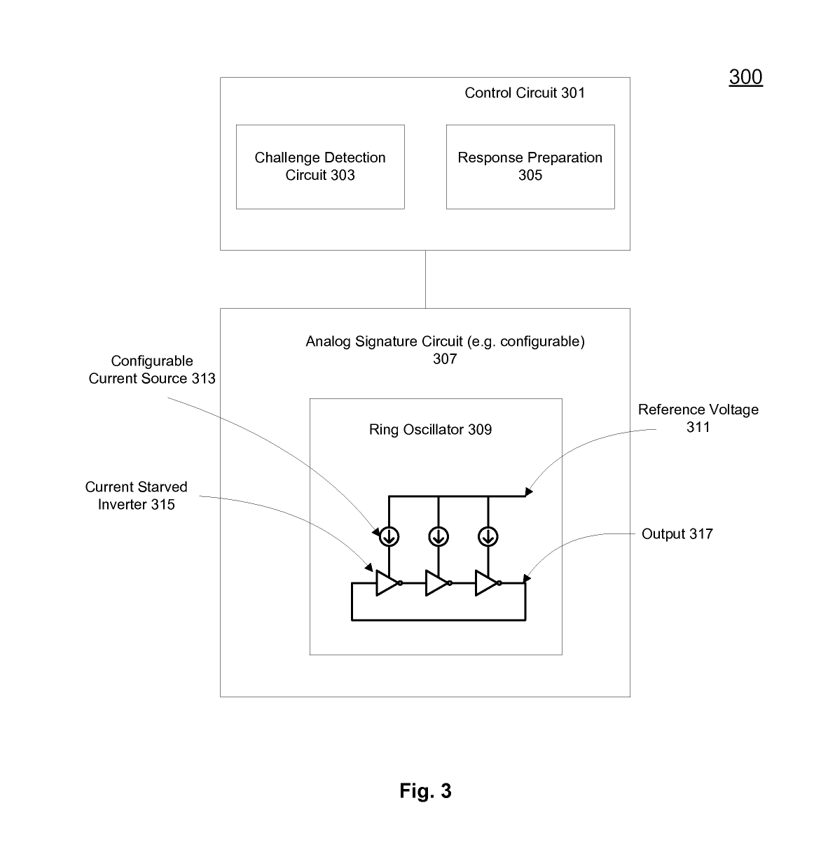

FIG. 3 is a block diagram illustrating one embodiment of circuits including an oscillator to perform analog authentication for a device. System 300 may include control circuit 301 and analog signature circuit 307, separately as part of, for example, control circuit 207 and analog signature circuit 211 in tag 201 of FIG. 2.

In one embodiment, control circuit 301 may include challenge detection circuit 303 capable of extracting a challenge (e.g. for device authentication) including analog portions and digital portions from a received signal. Challenge detection circuit 303 may detect or determine analog attributes directly from the received signal as analog values representing the analog portions of the challenge. The digital portions may include, for example, custom commands specifying a set of configuration parameters.

Control circuit 301 may include response preparation circuit 305 to provide a response to a challenge received via challenge detection circuit 303. Response preparation circuit 305 may configure analog signature circuit 307 according to configuration parameters specified in the received challenge. In one embodiment, response preparation circuit 305 can measure an output from analog signature circuit 307 (e.g. configured by the challenge) using an analog portion (e.g. time interval value) included in the challenge received. The measured output may be stored in a storage for later retrieval.

In one embodiment, analog signature circuit 307 may include a ring oscillator 309 to oscillate at a frequency uniquely determined by intrinsically unique physical properties of a device. Ring oscillator 309 may comprise an odd number of NOT gates (or inverters) whose output 317 oscillates between two voltage levels, representing true (e.g. 1) and false (e.g. 0). Ring oscillator 309 may include current starved inverter 315 coupled with configurable current source 313 with voltage reference 311 for higher range of frequency responses and small layout area (or other resource cost). Different currents from current source 313 may change the oscillation frequency of ring oscillator 309, for example, based on changes in delays along feedback paths within oscillator 309.

In some embodiments, configurable current source 313 may include a variable resistor component with configurable resistance to provide different levels of currents. The resistance of the variable resistor component may be selected (or configured) from one of multiple possible resistance values. For example, the variable resistor component may include a switch coupled with a resistor of a fixed resistance. The resistor may be shorted when the switch is turned on. Thus, the variable resistance can offer two levels of resistance depending on whether the switch is turned (or configured) on or off.

According to one embodiment, a configuration setting in a challenge received via challenge detection circuit 303 may comprise a binary word (e.g. 3 bit or other fixed number of bits). Each bit may indicate whether to turn a variable resistor component inside analog signature circuit 307 on or off. Response preparation circuit 305 may configure ring oscillator 309 to oscillate at a different frequencies by setting each switch on/off according the value of the corresponding bit in the binary word of the configuration setting.

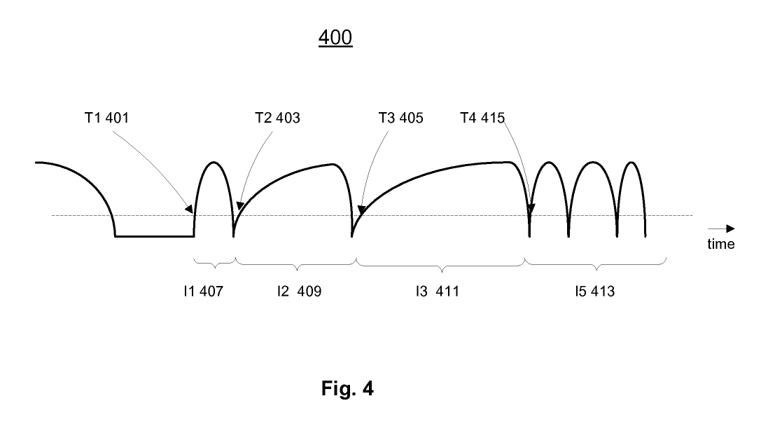

FIG. 4 is a waveform diagram illustrating an exemplary analog signal for dynamic authentication described herein. For example, waveform 400 may represent a signal carrying an analog challenge received via radio 205 for authenticating tag 201 in FIG. 2. In one embodiment, waveform 400 may be sent from an RFID reader to an RFID tag. Rising edges, T1 401, T2 403, T3 405, T4 415 may be detected to determine time durations (e.g. analog attributes) between adjacent edges for analog challenges.

For example, consecutive time periods I1 407, I2 409 and I3 411 may be identified to determine whether waveform 400 embeds an analog challenge specified by time period I3 411. In some embodiments, a pattern of consecutive time periods with short, long, and longer durations may signify a potential begin command, such as R->T Preamble according to EPC™ Radio-Frequency Identity Protocols, Version 1.1.0, 2005. If waveform 400 does not conform to requirements of the begin command (e.g. I1 407, I2 and I3 411 do not satisfy relative length requirements between a data 0 period, RTcal period, and TRcal), I3 411 may be identified as a time period for an analog challenge. Alternatively, if no commands could be parsed from time period I5 413, time period I3 411 may be recognized as an analog challenge. Waveform 400 may follow by special RFID commands specifying digital portions of the analog challenge if I3 411 is identified as an analog challenge.

In one embodiment, as consecutive time durations in a received signal, such as I1 407, I2 409 and I3 411, is detected, time period corresponding to I3 411 may be recorded, for example, based on number of ticks during this time period in an RFID tag. The recorded data may be discarded if no analog challenge is detected (e.g. the received signal carries a standard RFID command). As a result, analog challenges for device authentication may be integrated with existing systems implementing standard RFID devices with minimum cost for clone protection.

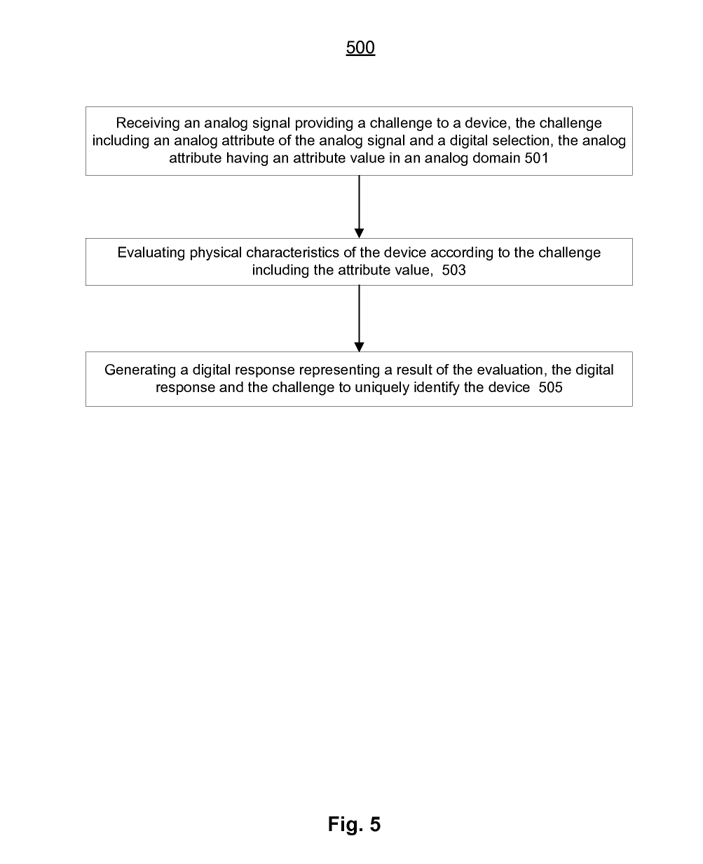

FIG. 5 is a flow diagram illustrating one embodiment of a process to generate a digital response for an analog challenge. For example, process 500 may be performed by some components of a clone protected device, such as target device 101 FIG. 1. At block 501, the processing logic of process 500 may receive an analog signal to provide a challenge to a device. The challenge may include an analog attribute of the analog signal and a digital selection. In one embodiment, the analog signal may carry the analog attribute and the digital challenge separately at different periods of time. The analog attribute may be associated with an attribute value in an analog domain, such as a time interval. The digital selection may specify a configuration settings (e.g. out of a predetermined number of possible settings) for the device.

At block 503, in one embodiment, the processing logic of process 500 may evaluate physical characteristics of a device according to an analog challenge received. For example, the processing logic of process 500 may count a number of oscillations of an oscillator circuit in the device for a period of time specified by the analog challenge. Alternatively or optionally, the processing logic of process 500 may collect or determine statistics (e.g. a total number, an average number, the maximum number, etc.) of other measurable characteristics applicable as unique signatures for the analog challenge to validate the device.

In one embodiment, a threshold level derived from components on the tag may be selected by a digital challenge, and an analog variable depth notch is send as the analog challenge. In one embodiment, a light level establishes a current, discharging a known capacitance, with the time interval determined by the time to discharge of the capacitor constituting an analog challenge. In one embodiment a signal level at the tag may be compared to levels established at the tag with digital configuration, forming the analog and digital challenge. In one embodiment, the components are all integrated into a single electronic chip. In one embodiment, the components are all integrated onto a single electronic die except for antenna. In one embodiment, the analog challenge may include a component external to the electronic die. In one component, a time interval challenge may be correlated to a mechanism which comprises an external component. In one embodiment, the external component is the resistance of an electrical path through a path external to the die.

In one embodiment, at block 505, the processing logic of process 500 may generate a digital response using unique physical characteristics of a device determined or evaluated according to an analog challenge. The result of the evaluation may be stored in a storage as a value represented, for example, in a known number of binary bits. For example, the evaluation result may comprise a number of oscillations counted from an oscillator of the device during a period of time specified in an analog challenge. The digital response combined with the corresponding analog challenge may uniquely characterize the device in an analog domain with substantially unlimited number of possible variations to eliminate opportunities to clone the device.

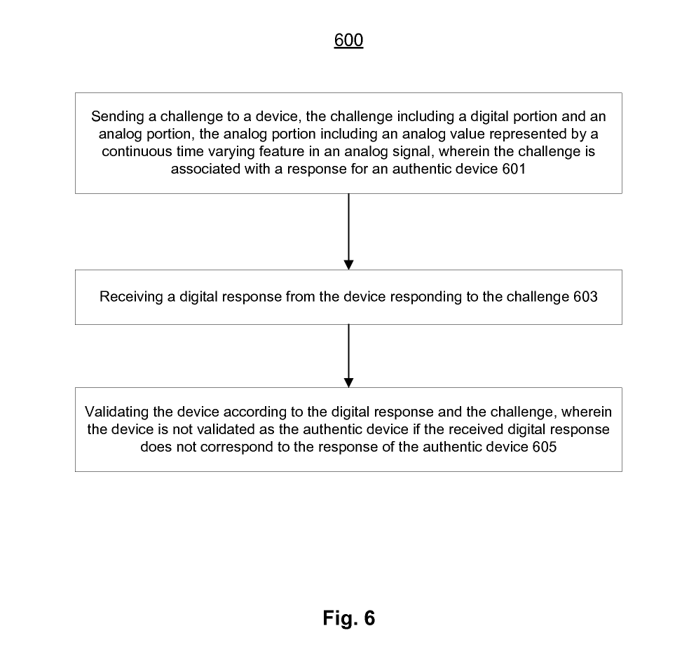

FIG. 6 is a flow diagram illustrating one embodiment of a process to send an analog challenge to receive a digital response. For example, process 600 may be performed by some components of an authentication device, such as device 107 of FIG. 1. In one embodiment, at block 601, the processing logic of process 600 may send a challenge to a device to validate whether the device is authentic, for example, manufactured via a known vendor. The challenge may include a digital portion and an analog portion. The analog portion of the challenge may include an analog attribute represented by a continuous time varying feature in an analog signal to allow an analog range of substantially unlimited possible values for the analog attribute. The challenge may be associated with a response to identify a type (or groups) of known devices. For example, the association may be part of a profile previously established for the known device. The analog portion of the challenge may allow a flexibility to design a substantially unique profile associated with a known device.

At block 603, in one embodiment, the processing logic of process 600 may receive digital data from a device responding to a previously sent analog challenge. For example, the processing logic of process 600 may send a read command to retrieve a response to the analog challenge. In some embodiments, the read command may identify a special address for storing a response to an analog challenge received at the device.

The processing logic of process 600 may validate a device according to digital response (or data) received from the device responding to an analog challenge. In one embodiment, the processing logic of process 600 may perform an analysis to compare a profile of a known device and the combination of the digital response and the challenge to determine whether there is a match between the profile and the digital response received. The device may not be validated as the known device if the digital response fails to match a response associated with the challenge in the profile.

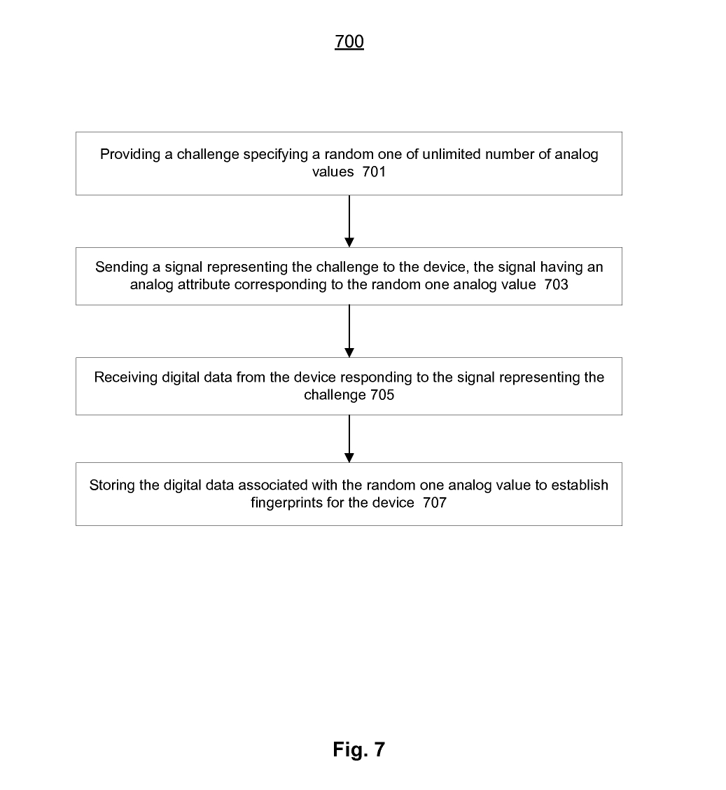

FIG. 7 is a flow diagram illustrating one embodiment of a process to provide challenges with analog values to uniquely characterize a device. For example, process 700 may be performed by some components of system 100 of FIG. 1. In one embodiment, at block 701, the processing logic of process 700 may provide a challenge specifying a random one of unlimited number of possible analog values. The random value may be selected to establish a profile to characterize a known device.

In one embodiment, a profile of a known device may include pairs of challenge and corresponding response. Each challenge may include an analog value as an analog challenge in an analog domain (e.g. time domain) to significantly lower the possibility for a clone device to cover potential analog challenges selectable to profile the known device. A response paired with the challenge may be unique for the known device.

At block 703, the processing logic of process 700 may send a signal representing an analog challenge to a device to obtain a corresponding response specific to the device for the analog challenge. In one embodiment, an analog value of the analog challenge may be carried directly by the waveform of the signal. For example, an analog attribute of the waveform of the signal may carry or correspond to the analog value of the analog challenge.

In response, at block 705, the processing logic of process 700 may receive digital data from a device being profiled. The digital data may be generated in the device responding to a previously sent analog challenge. The processing logic of process 700 may store the received digital data associated with an analog value of the analog challenge designated for a profile of the device at block 707. The profile including both digital responses and analog challenges may be stored as unique fingerprints for validating genuine (e.g. non cloned or counterfeited) devices or types of devices.

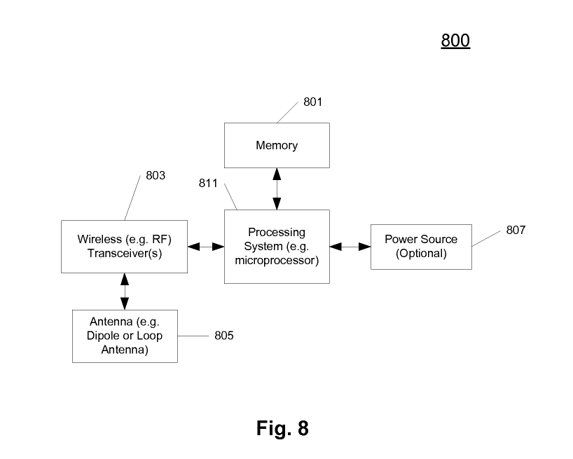

FIG. 8 illustrates one example of a typical clone protected system which may be used in conjunction with an embodiment described herein. For example, system 800 may be implemented as part of system as shown in FIG. 2. The data processing system 800 shown in FIG. 8 includes a processing system 811, which may be one or more microprocessors, or which may be a system on a chip integrated circuit, and the system also includes memory 801 for storing data and programs for execution by the processing system.

The system 800 also includes one or more wireless transceivers 803 to communicate with another data processing system. A wireless transceiver may be a RF transceiver for an active RFID network. An antenna system 805 may be coupled with the wireless transceiver 803. Additionally, system 800 may optionally include a power source 807. The power source may be a built-in battery or a replaceable battery. In one embodiment, power source 807 may be based on solar energy source or driven by an external energy source. It will be appreciated that additional components, not shown, may also be part of the system 800 in certain embodiments, and in certain embodiments fewer components than shown in FIG. 8 may also be used in a data processing system.

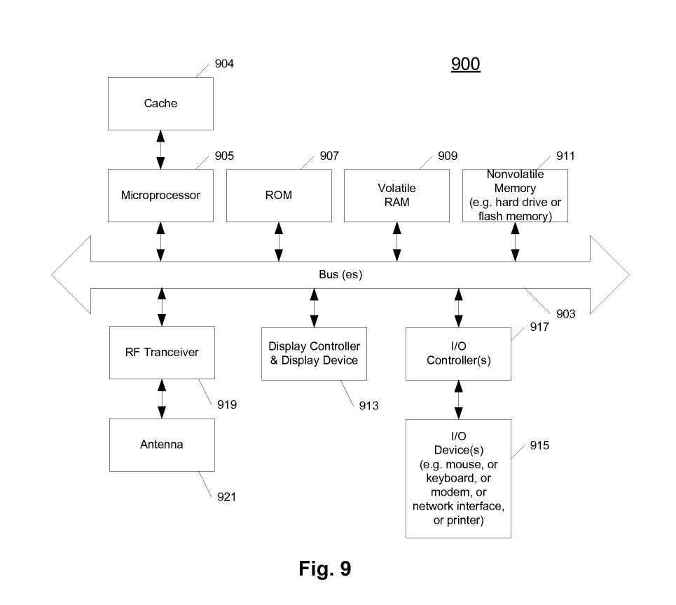

FIG. 9 illustrates an example of a data processing system that may be used with one embodiment of a clone protected device of the present invention. For example, the system 900 (e.g. in an RFID reader device) may be implemented as a part of the systems shown in FIG. 1. Note that while FIG. 9 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 9, the system 900, which is a form of a data processing system, includes a bus 903 that is coupled to a microprocessor(s) 905, a ROM (Read Only Memory) 907, volatile RAM 909, and a non-volatile memory 911. The microprocessor 903 may retrieve the instructions from the memories 907, 909, 911 and execute the instructions to perform operations described above. The bus 903 interconnects these various components together and also interconnects these components 905, 907, 909, and 911 to a display controller and display device 913 and to peripheral devices such as input/output (I/O) devices 915 which may be mice, keyboards, modems, network interfaces, printers and other devices, which are well known in the art. Typically, the input/output devices 915 are coupled to the system through input/output controllers 917. The volatile RAM (Random Access Memory) 909 is typically implemented as dynamic RAM (DRAM) which requires power continually in order to refresh or maintain the data in the memory.

Additionally, a wireless transceiver 919 may be coupled with bus 903 to provide an interface to a wireless network. The wireless transceiver 919 may be a radio frequency (RF) transceiver (e.g., an RF transceiver for an RFID wireless network) or a Wi-Fi transceiver for IEEE 802 based wireless network. Transceiver 919 may be coupled with an antenna system 921.

The mass storage 911 is typically a magnetic hard drive or a magnetic optical drive or an optical drive or a DVD RAM or a flash memory or other types of memory systems which maintain data (e.g. large amounts of data) even after power is removed from the system. Typically, the mass storage 911 will also be a random access memory although this is not required. While FIG. 9 shows that the mass storage 911 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 903 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description above. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A method to identify a device, the method comprising:
receiving an analog signal providing a challenge to the device, the challenge including a digital selection and an analog attribute of the analog signal, the analog attribute having an attribute value in an analog domain;
evaluating physical characteristics of the device according to the challenge including the attribute value and the digital selection; and
generating a response including a result of the evaluation, the response and the challenge to authenticate the device.

2. The method of claim 1, wherein the analog signal corresponds to a waveform, wherein the waveform includes a plurality of occurrences of a predetermined pattern of variation and wherein the analog attribute indicates a pair of consecutive occurrences of the predetermined pattern of variation.

3. The method of claim 2, wherein the predetermined pattern of variation comprises a rising interval of time in the waveform, wherein the waveform rises above a rate of change within the rising interval.

4. The method of claim 2, wherein the attribute value represents time interval between the pair of consecutive occurrences of the predetermined pattern of variation in the waveform.

5. The method of claim 4, wherein the analog domain comprises unlimited possible time values.

6. The method of claim 1, wherein the evaluation comprises:
performing a function according to the physical characteristics; and
measuring the output of the function for the result, wherein the measuring is based on the attribute value.

7. The method of claim 6, wherein the function comprises oscillation operations and wherein the output indicates a frequency of the oscillation operations.

8. The method of claim 6, wherein the function is configurable via the challenge, wherein the digital selection includes one or more configuration parameters and wherein the physical characteristics include a configurable portion, the method further comprising:
configuring the configurable portion of the physical characteristics via the configuration parameters.

9. The method of claim 8, wherein the configurable portion comprises one or more variable resistor components and wherein resistances of the resistor components are specified in the configuration parameters.

10. The method of claim 6, wherein the analog attribute includes a start instance and an end instance and wherein the measurement comprises:
collecting a statistic of the output of the function over a period of time between the start instance and the end instance, wherein the result includes the statistic collected.

11. The method of claim 10, wherein the function is an oscillation function and wherein the statistics comprises a count of oscillations via the oscillation function over the period of time.

12. The method of claim 1, wherein the result of the evaluation is stored in a storage of the device, and wherein the generation comprises:
retrieving the result of the evaluation from the storage for the response.

13. The method of claim 12, wherein the retrieving is based on an RFID (radio frequency identifier) read command.

14. The method of claim 1, wherein the analog signal is wirelessly received via a dipole antenna.

15. A method to authenticate a device, the method comprising:
sending a digital portion of a challenge to the device;
sending an analog portion of the challenge to the device, the analog portion including an analog value represented by a continuous time varying feature in an analog signal, wherein the continuous time varying feature allows substantially unlimited number of possible selections of the analog value for the challenge, and wherein the challenge is associated with a response for an authentic device;
receiving a digital response from the device responding to the challenge; and
validating the device according to the digital response and the challenge, wherein the device is not validated as the authentic device if the received digital response does not correspond to the response the authentic device.

16. The method of claim 15, wherein the analog attribute specifies a time interval and wherein the digital response includes a count counted during the time interval.

17. The method of claim 15, wherein the challenge includes a configuration setting to configure the device and wherein the digital response represents a measure of physical characteristic of the device configured via the configuration setting and wherein the analog attribute provides a continuous scale of precision for the measure.

18. The method of claim 17, wherein the measure indicates a frequency of an oscillation circuitry converting the physical characteristics in the device to the frequency, wherein the physical characteristics include configurable resistor components of the oscillation circuitry and wherein the configurable resistor components are configured via the configuration setting of the challenge.

19. The method of claim 15, further comprising:
sending a digital command to retrieve the digital response from the device after sending the digital and analog portions of the challenge, wherein the digital response is received in response to the digital command.

20. The method of claim 15, wherein a first profile is stored in a storage for the type of device, wherein the first profile includes pairs of challenge and corresponding responses previously received from a known device of the type, and wherein the determining the identity of the device comprises:
establishing a second profile for the device using the challenges of the first profile, the second profile including pairs of the challenges and corresponding responses; and
comparing the first profile and second profile, wherein the device is identified with the type of device if the first profile substantially matches the second profile.

21. The method of claim 15, wherein the challenge is wirelessly received at the device via a dipole antenna.

22. A method to characterize a device, the method comprising:
providing a challenge specifying a random one of unlimited number of analog values;
sending a signal representing the challenge to the device, the signal having an analog attribute corresponding to the random one analog value;
receiving digital data from the device responding to the signal representing the challenge; and
storing the digital data paired with the random one analog value to establish fingerprints of the device.

23. An RFID device comprising:
an detector to receive an analog signal providing an analog portion of a challenge to the device, the analog portion of the challenge including an analog attribute of the analog signal and the challenge including a digital selection to configure the tag device;
a control circuit to detect the analog attribute from the analog signal, wherein the analog attribute has an analog value; and
a signature circuit having physical properties not known outside the tag device, the signature circuit interacting with the challenge to generate a response, wherein the response is retrievable via the antenna, and wherein the analog attribute allows authentication of the tag device via the response paired with the challenge having the analog value.

24. The RFID device of claim 23, wherein the control circuit comprises an analog measurement circuit to provide an analog measure for the signature circuit based on the analog value received from the analog signal.

25. The RFID device of claim 24, further comprising:
a storage to store the analog measure, wherein the response includes the analog measure retrieved from the storage.

26. The RFID device of claim 23, wherein the control circuit comprises:
a configuration circuit to configure the signature circuit with the digital selection to allow varied responses from the signature circuit to different challenges sharing a common analog value for the analog attribute.

27. The RFID device of claim 23, wherein the detector comprises a dipole antenna.

28. An RFID device comprising:
an oscillator circuit to generate a frequency unique to the tag device;
an antenna to receive an analog signal for a challenge to the tag device, the challenge including an analog attribute of the analog signal; and
a control circuit configured to
detect the analog attribute from the analog signal, and
provide a response to the challenge as a measurement of the frequency according to the analog attribute,
wherein the response is retrievable via the antenna, wherein the analog attribute has an analog value to allow identification of the tag device via the response paired with the challenge.

29. The RFID device of claim 28, wherein the antenna is a dipole antenna.

30. A reader device for authenticating a device, comprising:
a memory storing executable instructions;
a wireless network interface coupled to the device;
a processor coupled to the memory and the wireless network interface to execute the instructions from the memory, the processor being configured to
send a digital portion of a challenge to the device via the wireless network interface,
send an analog portion of the challenge to the device via the wireless network interface, the analog portion including an analog value represented by a continuous time varying feature in an analog signal, wherein the continuous time varying feature allows substantially unlimited number of possible selections of the analog value for the challenge, and wherein the challenge is associated with a response for an authentic device,
receive a digital response from the tag device responding to the challenge via the wireless network interface, and
validate the device according to the digital response and the challenge, wherein the device is not validated as the authentic device if the received digital response does not correspond to the response the authentic device.
